(19) United States
(12) Patent Application Publication
(10) Pub. No.: US 2009/0063994 A1
(43) Pub. Date: Mar. 5, 2009

(54) Providing a Content Mark

(75) Inventors: Lisa A. Pickelsimer, Atlanta, GA (US); Mark Gathen, Atlanta, GA (US); Joshua Musick, Brooklyn, NY (US); Robert Fabricant, Brooklyn, NY (US)

Correspondence Address: MERCHANT & GOULD PC, P.O. BOX 2903, MINNEAPOLIS, MN, 55402-0903, US

(73) Assignee: Cox Communications, Inc., Atlanta, GA (US)

(21) Appl. No.: 12/126,096

(22) Filed: May 23, 2008

Related U.S. Application Data
(63) Continuation-in-part of application No. 11/787,732, filed on Apr. 17, 2007.
(60) Provisional application No. 60/881,888, filed on Jan. 23, 2007.
(60) Provisional application No. 60/897,341, filed on Jan. 25, 2007.
(60) Provisional application No. 60/946,790, filed on Jun. 28, 2007.
(60) Provisional application No. 60/931,698, filed on May 25, 2007.

(51) Int. Cl. G06F 3/048; G06F 15/16

(52) U.S. Cl. 715/753

(57) ABSTRACT

A content mark may be provided. First, an invitation input may be received from a first user. The invitation input may comprise a recommendation to a second user to take an action regarding content to be delivered over a content delivery system. In addition, the invitation input may include a pointer corresponding to a predetermined point in the content to be delivered. Next, the invitation input may be transmitted to the second user. Then an acceptance of the invitation input may be received from the second user. In response to the received acceptance, the content may be transmitted to the second user. The content may be configured to start at the predetermined point determined, for example, by the first user.

### RELATED APPLICATIONS

Under provisions of 35 U.S.C. § 119(e), Applicants claim the benefit of U.S. Provisional Application No. 60/946,790, filed Jun. 28, 2007, and U.S. Provisional Application No. 60/931,698, filed May 25, 2007, both of which are hereby incorporated by reference.

This application is a continuation-in-part (CIP) of U.S. application Ser. No. 11/787,732, filed Apr. 17, 2007, which is incorporated herein by reference. U.S. application Ser. No. 11/787,732, filed Apr. 17, 2007, claimed the benefit of U.S. Provisional Application No. 60/881,888, filed Jan. 23, 2007, and U.S. Provisional Application No. 60/897,341, filed Jan. 25, 2007, under provisions of 35 U.S.C. § 119(e).

Related U.S. application Ser. No. 11/651,140, filed on Jan. 9, 2007, and U.S. application Ser. No. 11/787,733, filed on Apr. 17, 2007 are hereby incorporated by reference.

Related U.S. application Ser. No. ______, entitled “PROVIDING A VIDEO USER INTERFACE” (60136.0036US11), U.S. application Ser. No. ______, U.S. application Ser. No. ______, entitled “PROVIDING A SOCIAL NETWORK” (60136.0036US12), U.S. application Ser. No. ______, entitled “PROVIDING A USER INTERFACE” (60136.0036US14), and U.S. application Ser. No. ______, entitled “PROVIDING A CUSTOMIZED USER INTERFACE” (60136.0036US15), filed on even date herewith in the name of Lisa A. Pickelsimer et al., assigned to the assignee of the present application, are also hereby incorporated by reference.

### BACKGROUND

Service providers may deliver content to a user over a content delivery system. For example, conventional content delivery systems distribute the content to a first user and a second user independently. In other words, the first user may watch a sports program while the second user may simultaneously watch a video-on-demand program. Independent content use, however, does not create a socialized entertainment sense with the users. Consequently, the first user may be socially detached and isolated from the second user. Stated another way, the conventional content delivery system may present an impersonal and unsocial user experience.

### SUMMARY

Consistent with embodiments of the present invention, systems and methods are disclosed for providing a content mark. First, an invitation input may be received from a first user. The invitation input may comprise a recommendation to a second user to take an action regarding content to be delivered over a content delivery system. In addition, the invitation input may include a pointer corresponding to a predetermined point in the content to be delivered. Next, the invitation input may be transmitted to the second user. Then an acceptance of the invitation input may be received from the second user. In response to the received acceptance, the content may be transmitted to the second user. The content may be configured to start at the predetermined point determined, for example, by the first user.

Both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment including an application server;

FIG. 2 is a block diagram of the communications processor; and

FIG. 3 is a flow chart of a method for providing a content mark.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Service providers may deliver content to users over a content delivery system independently. For example, a first user may receive a sports program from the content delivery system while a second user may simultaneously receive a video-on-demand program from the content delivery system. Independent content use by the users, however, does not create a socialized entertainment experience. Consistent with embodiments of the invention, a content mark may be provided. First, an invitation input may be received from a first user. The invitation input may comprise a recommendation to a second user to take an action regarding content to be delivered over a content delivery system. For example, the invitation input may suggest that the second user view a particular Video-on-Demand (VOD) program. In addition, the invitation input may include a pointer corresponding to a predetermined point in the content (e.g. VOD program) to be delivered. The first user may determine the predetermined point and may include a message to the second user regarding the predetermined point. Next, the invitation input may be transmitted to the second user. Then an acceptance of the invitation input may be received from the second user. In response to the received acceptance, the content or an indicator of the predetermined point along with a reference to the content (where the content may be independently accessible to the second user) may be transmitted to the second user. The content may be configured to start at the predetermined point determined, for example, by the first user. Consequently, the first user may be socially engaged with the second user providing a personalized experience for both the first and second users.

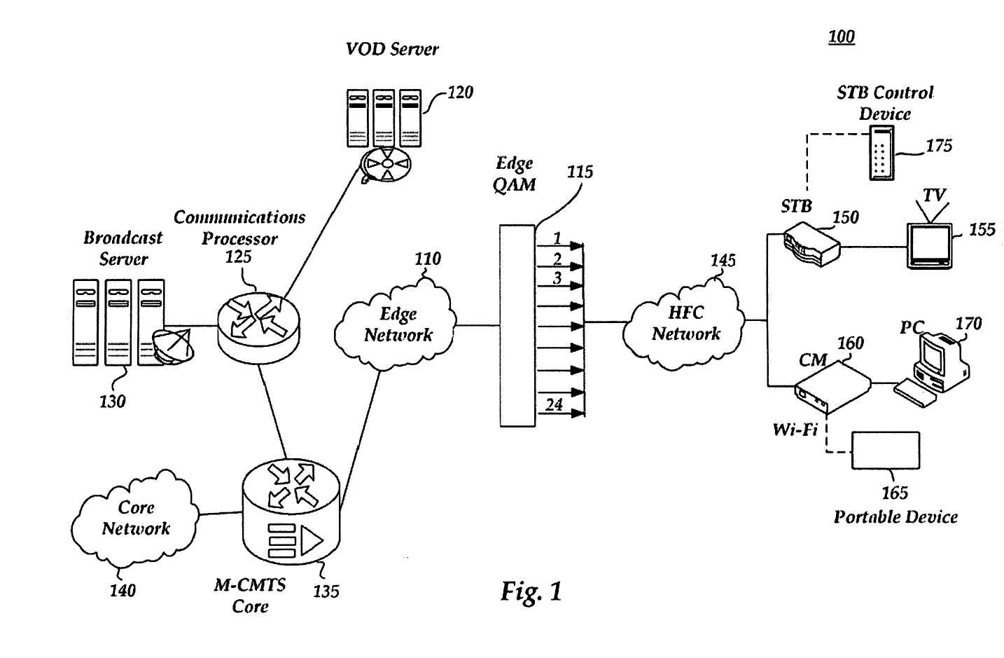

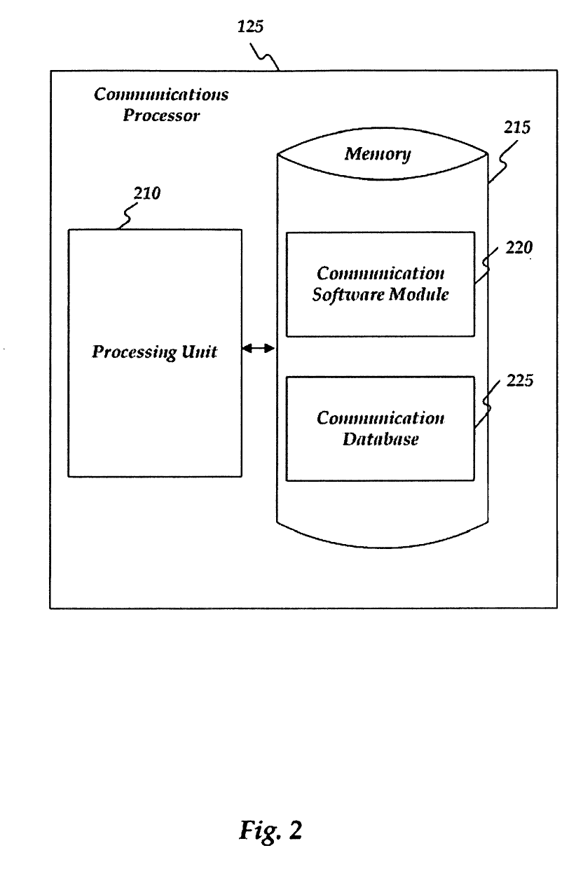

FIG. 1 is a block diagram of a content delivery system 100. Consistent with embodiments of the present invention, system 100 may comprise an edge network 110, an edge quadrature amplitude modulation (QAM) device 115, a video-on-demand (VOD) server 120, a communications processor 125, a broadcast server 130, a modular cable modem termination system (M-CMTS) core 135, and a core network 140. In addition, system 100 may comprise, a hybrid fiber-coax (HFC) network 145, a set-top-box (STB) 150, a television (TV) 155, a cable modem (CM) 160, a portable device 165, a personal computer (PC) 170, and a STB control device 175. Communications processor 125 will be discussed in greater detail below with respect to FIG. 2.

Edge network 110 may comprise, a network providing, for example, full-duplex, two-way broadband services including broadband video and audio, cable television services, or telecommunications services. Edge network 110 may provide data by utilizing network data formats including, for example, i) Internet protocol (IP); ii) Ethernet; iii) digital subscriber line (DSL); iv) asynchronous transfer mode (ATM); and v) virtual private network (VPN). Edge network 110 may utilize managed network services. Edge network 110 may comprise various components including, for example, i) servers; ii) switches; iii) routers; iv) gateways; v) hubs; vi) fiber optic cable; vii) copper cable; and viii) terminations. The aforementioned are examples and edge network 110 may comprise other configurations for broadband service delivery and data switching over system 100.

Edge QAM 115 may provide modulation for various encoding formats (e.g. for data, audio, and video) and may distribute the signal down multiple broadband channels. Edge QAM 115 may modulate signals in, for example, multi-channel quadrature amplitude modulation. Edge QAM 115 may support broadcast and narrowcast with multi-program transport stream (MPTS) pass-through and single-program transport stream (SPTS) to MPTS multiplexing. Edge QAM 115 may meet data-over-cable service interface specification (DOCSIS) and downstream radio frequency interface (DRFI) performance specifications. Furthermore, edge QAM 115 may provide video over internet protocol and moving pictures expert group (MPEG) video simultaneously. Edge QAM 115 may provide various data switching functions and enable two-way, full-duplex communication within the broadband network. Edge QAM 115 may modulate and distribute broadcast multimedia services including, for example, i) a broadcast multi-media service; ii) a high-definition multimedia service; iii) a digital television multimedia service; iv) an analog multimedia service; v) a VOD service; vi) a streaming video service; vii) a multimedia messaging service; viii) a voice-over-internet protocol service (VoIP); ix) an interactive multimedia service; and x) an e-mail service. The aforementioned are examples and edge QAM 115 may comprise other configurations for different broadband and data services.

VOD server 120 may perform processes for providing video entertainment on demand. VOD server 120 may take MPEG compressed video off a hard disk or a networked service, format it into MPEG-TS packets inside a user datagram protocol (UDP) packet, and send it into edge network 110. Edge QAM 115 may receive the UDP packets, where Internet protocol (IP) encapsulation may be removed. The MPEG packets may be forwarded down one QAM channel on edge QAM 115 and onto HFC network 145.

Broadcast server 130 may perform processes for providing broadcast services. Broadcast server 130 may use a broadcast signal and a narrowcast signal to deliver broadcast services to a broadcast system. Broadcast server 130 may receive video, audio, and data from fiber optic input, wireless input, recorded tape, recorded digital video disc, or satellite input. Broadcast server 130 may utilize digital signal formats and analog signal formats. Furthermore, broadcast server 130 may comprise a specialized receiver and data switching equipment for broadband distribution including, for example, using switched digital technology for broadcast video delivery to digital set-tops. In addition, broadcast server 130 may provide broadband multimedia services including, for example, i) the broadcast multi-media service; ii) the high-definition multimedia service; iii) the digital television multimedia service; iv) the analog multimedia service; v) the VOD service; vi) the streaming video service; vii) the multimedia messaging service; viii) the voice-over-internet protocol service (VoIP); ix) the interactive multimedia service; and x) the e-mail service. The aforementioned are examples and broadcast server 130 may comprise other components and systems for providing broadcast services in system 100.

M-CMTS core 135 may receive IP datagrams from core network 140. M-CMTS core 135 may then forward these IP datagrams to either a single QAM channel within edge QAM 115 with traditional DOCSIS encapsulation, or may forward the IP datagrams to multiple QAM channels within edge QAM 115, for example, using DOCSIS bonding. M-CMTS core 135 may support DOCSIS features and end-to-end IP within a next generation network architecture (NGNA), for example.

Core network 140 may comprise any data or broadband network that may provide data and services to edge network 110, communications processor 125, broadcast server 130, or M-CMTS core 135. For example, core network 140 may comprise the Internet. In addition, core network 140 may comprise various components including, for example, i) servers; ii) switches; iii) routers; iv) gateways; v) hubs; vi) fiber optic cable; vii) copper cable; and viii) terminations. The aforementioned are examples and core network 140 may comprise other components and may supply other services using various other formats.

HFC network 145 may comprise a communications network (e.g. a cable TV network) that uses optical fiber, coaxial cable, or an optical fiber coaxial cable combination. Fiber in HFC network 120 may provide a high-speed backbone for broadband services. Coaxial cable may connect end users in HFC network 120 to the backbone. Such networks may use, for example, matching DOCSIS cable modems at a head end and at an end user's premises. Such a configuration may provide bi-directional paths and Internet access.

STB 150 may comprise a single component or a multi-component system for receiving broadband services. STB 150 may comprise a service consumer system combining several components including, for example, a set top box, cable modem 160, a network interface unit, a residential gateway, a terminal unit, a scrambler/descrambler, a digital storage media unit, an input/output port, a display device, a keyboard, and a mouse. STB 150 may encode and decode digital and analog signals, and provide interface capability for other components. STB 150 may utilize various operating systems and other software components. The end user's premises may contain STB 150. STB 150 may include all the functionality provided by a cable modem, such as CM 160, in one component and attach to TV 155, for example.

TV 155 may comprise an end use device for displaying delivered broadband services. TV 155 may comprise, for example, a television, a high definition television, a liquid crystal display unit (LCD), a video projection unit, or PC 170. The aforementioned are examples and TV 155 may comprise other display devices for delivered broadband services.

CM 160 may comprise, for example, a cable modem, a network server, a wireless fidelity data switch, or an Ethernet switch. CM 160 may provide data services to the user by accessing DOCSIS services from system 100. CM 160 may provide Internet access, video, or telephone services. The aforementioned are examples and CM 160 may comprise other data delivery devices.

Portable device 165 or PC 170 may comprise any personal computer, network switch, wireless switch, network hub, server, personal digital assistant, and home computing device. Portable device 165 or PC 170 may serve as user devices for data access from system 100. Portable device 165 and PC 170 may transmit and receive data and services from system 100.

STB control device 175 may comprise any input and output device for interfacing with STB 150. For example, STB control device 175 may be a remote control for using STB 150. STB control device 175, after proper programming, may interface with STB 150.

Furthermore, system 100 maybe configured to utilize Open Cable Applications Platform (OCAP.) OCAP was developed by Cable Television Laboratories, Inc. of Louisville, Colo. 80027-9750, as a common interactive TV platform. OCAP is a specification for a middleware software layer that enables application developers, interactive television services, and various other products to run interactive applications on content delivery system such as television systems.

Embodiments consistent with embodiments of the invention may comprise a system for providing user communication. The system may comprise a memory storage and a processing unit coupled to the memory storage. The processing unit may be operative to receive an invitation input from a first user. The invitation input may comprise a recommendation to a second user to take an action regarding delivered content, delivered over a content delivery system. Furthermore, the processing unit may be operative to transmit the invitation input to the second user.

Consistent with embodiments of the present invention, the aforementioned memory, processing unit, and other components may be implemented in a content delivery system, such as system 100 of FIG. 1. Any suitable combination of hardware, software, and/or firmware may be used to implement the memory, processing unit, or other components. By way of example, the memory, processing unit, or other components may be implemented with communications processor 125, in combination with system 100. The aforementioned system and processors are examples and other systems and processors may comprise the aforementioned memory, processing unit, or other components, consistent with embodiments of the present invention.

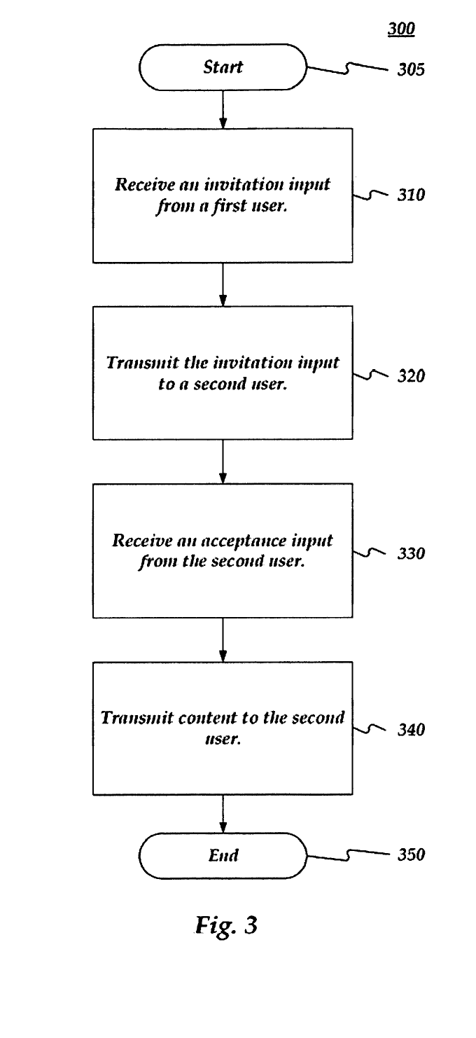

FIG. 2 shows communications processor 125 of FIG. 1 in more detail. As shown in FIG. 2, communications processor 125 may include a processing unit 210 and a memory unit 215. Memory 215 may include a communication software module 220 and a communication database 225. While executing on processing unit 210, communication software module 220 may perform processes for providing user communication, including, for example, one or more stages included in method 300 described below with respect to FIG. 3. Furthermore, any communication software module 220 and communication database 225 may be executed on or reside in any element shown in FIG. 1.

Communications processor 125 (“the processor”) may be implemented using a personal computer, a network computer, a mainframe, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

FIG. 3 is a flowchart setting forth the general stages involved in a method 300 consistent with an embodiment of the invention for providing a content mark. Method 300 may be implemented using communications processor 125, as described above with respect to FIG. 2. Ways to implement the stages of method 300 will be described in greater detail below. Method 300 may begin at starting block 305 and proceed to stage 310 where communications processor 125 may receive an invitation input from a first user. The invitation input may comprise a recommendation to a second user to take an action regarding content to be delivered over content delivery system 100. For example, the invitation input may be created by the first user using a first user device. The first user device may comprise STB 150, CM 160, portable device 165, PC 170, TV 155 (e.g. enabled with two-way OCAP), or STB control device 175. When creating the invitation input, the first user may include, for example, an address identifying the second user. For example, the invitation input may include a second user's username, a second user's control device identification, a second user's account number, or a second user's e-mail address. The aforementioned are examples and the address identifying the second user may comprise other information and the first user device may comprise other elements.

Furthermore, as stated above, the invitation input may comprise the recommendation to the second user to take the action regarding the content to be delivered over content delivery system 100. The first user may include, in the invitation input, a recommendation to the second user to view a particular program (e.g. a VOD program.) For example, the first user may be viewing the particular program. While viewing the program, the first user may remember a past conversation the first user had with the second user regarding or otherwise relative to a portion of the content the first user is viewing. Consequently, the first user may want the second user to see this portion of the program. Moreover, the first user may want to pass a message to the second user regarding this portion of the content. Accordingly, the invitation input may include a pointer corresponding to this portion of the program (e.g. a predetermined point in the content to be delivered.) The pointer may comprise, for example, any element or information capable of identifying a point in the content and a duration of the portion of the content.

From stage 310, where communications processor 125 receives the invitation input from the first user, method 300 may advance to stage 320 where communications processor 125 may transmit the invitation input to the second user. For example, communications processor 125 may parse the invitation input for the address for the second user or may obtain the address for the second user in any manner. Once communications processor 125 has the address for the second user, communications processor 125 may transmit the invitation input to the second user through system 100. Communications processor 125 may store the invitation input for later retrieval. Furthermore, communications processor 125 may redirect the invitation input to another system, for example, an Ethernet data system or the Internet.

Communications processor 125 may transmit the invitation input to the second user device. For example, the address for the second user may correspond to the second user device, a memory location in the second user device, or a file storage folder within the second user device. The second user device may comprise STB 150, CM 160, portable device 165, PC 170, TV 155 (e.g. enabled with two-way OCAP), or STB control device 175. Communications processor 125 may perform processing on the invitation input, including aggregating with other invitation inputs, system data, and data from other system users. The invitation input may be viewed on the second user device by the second user. The second user may choose to ignore the invitation input, may delay responding to the invitation input, or may immediately respond to the invitation input.

From stage 320, where communications processor 125 transmits the invitation input to the second user, method 300 may advance to stage 330 where communications processor 125 may receive an acceptance input from the second user. For example, in response to receiving the invitation input, the second user may consider the invitation input and enter the acceptance input into the second user device. The acceptance input may be in response to the invitation input. For example, the second user may respond to the invitation input by rejecting the invitation input, postponing the invitation input, storing the invitation input for later retrieval, or sending a different content recommendation to the first user. The acceptance input may be transmitted from the second user device through system 100 or any other system. The acceptance input from the second user may not necessarily be a function of system 100. System 100 may be built so that the second user may receive the invitation input and take autonomous action on any recommendation or other element attached to the invitation input without notification being given to the first user.

From stage 330, where communications processor 125 receives the acceptance input from the second user, method 300 may advance to stage 340 where communications processor 125 may transmit content to the second user. For example, communications processor 125 may transmit the content to the second user through system 100 or any other system. For example, communications processor 125 may transmit the particular program described above with respect to stage 310 to the second user. The content may comprise only that portion of the particular program corresponding to the aforementioned pointer defined, for example, by the first user. In addition, communications processor 125 may transmit all of the particular program described above with respect to stage 310 and the pointer corresponding to the first user indicated portion of the program. In this case, SBT 150 (or CM 160) may use the pointer and cause the first user indicated portion of the program to be displayed on TV 155 (or PC 170.) Once communications processor 125 transmits the content to the second user in stage 340, method 300 may then end at stage 350.

Consistent with embodiments of the invention, the content may be delivered to the second user independent of communications processor 125 or system 100. However, communications processor 125 may be utilized to synchronize the content and the pointer to create an intended second user viewing experience. For example, an invitation input may be received from the first user. The invitation input may comprise a recommendation to the second user to take an action regarding content. The content may be delivered to the second user independent of system 100. For example, the second user may have received the content in any way and is not limited to receiving the content from system 100 or using processor 125. For example, the invitation input may suggest that the second user view a particular Video-on-Demand (VOD) program. In addition, the invitation input may include a pointer corresponding to a predetermined point in the content (e.g. VOD program) and data indicating a duration of the content measured from the predetermined point. The first user may determine the duration and predetermined point and may include a message to the second user regarding the predetermined point. Communications processor 125 may be utilized to synchronize the content and the pointer. Next, the invitation input may be transmitted to the second user. Then an acceptance of the invitation input may be received from the second user. In response to the received acceptance, an indicator of the predetermined point along with a reference to the content (where the content is independently accessible to the second user) may be transmitted to the second user.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a content mark, the method comprising:
receiving an invitation input from a first user, the invitation input comprising a recommendation to a second user to take an action regarding content to be delivered over a content delivery system, the invitation input including a pointer corresponding to a predetermined point in the content to be delivered; and
transmitting the invitation input to the second user.

2. The method of claim 1, wherein receiving the invitation input including the pointer comprises receiving the invitation input including the pointer comprising data indicating a duration of a portion of the content measured from the predetermined point.

3. The method of claim 1, wherein receiving the invitation input comprises receiving the invitation input from the first user, the invitation input comprising the recommendation to the second user to take the action regarding content to be delivered over the content delivery system, the invitation input including the pointer corresponding to the predetermined point in the content to be delivered, the predetermined point being determined by the first user.

4. The method of claim 1, wherein receiving the invitation input comprises receiving the invitation input from the first user, the invitation input comprising the recommendation to the second user to take the action regarding content to be delivered over the content delivery system, the invitation input including a message from the first user to the second user regarding the content.

5. The method of claim 1, wherein receiving the invitation input comprises receiving the invitation input over the content delivery system.

6. The method of claim 1, wherein receiving the invitation input comprises receiving the invitation input from a first user device.

7. The method of claim 1, wherein receiving the invitation input comprises receiving the invitation input from a first user device comprising one of the following: a network interface unit, a residential gateway, a set-top box, a terminal unit, a scrambler/descrambler, a digital storage media unit, a control device, a television, an LCD screen, a cable modem, a computer, and a projection unit.

8. The method of claim 1, wherein receiving the invitation input comprises receiving the invitation input indicating the second user.

9. The method of claim 1, wherein receiving the invitation input from the first user, the invitation input comprising the recommendation to the second user to take the action regarding content to be delivered over the content delivery system comprises receiving the invitation input from the first user, the invitation input comprising the recommendation to the second user to take the action regarding content to be delivered over the content delivery system comprising one of the following: a full-duplex, two-way broadband network, a hybrid fiber-coax (HFC) network, a data network, the internet, cable television network, and a telecommunications network.

10. The method of claim 1, wherein receiving the invitation input from the first user, the invitation input comprising the recommendation to the second user to take the action regarding content to be delivered over the content delivery system comprises receiving the invitation input from the first user, the invitation input comprising the recommendation to the second user to take the action regarding content comprising one of the following: a high-definition multimedia service, a digital television multimedia service, an analog multimedia service, a Video-on-Demand service, and a video delivered to a personal computer (PC) service.

11. The method of claim 1, wherein transmitting the invitation input comprises transmitting the invitation input over the content delivery system.

12. The method of claim 1, wherein transmitting the invitation input comprises transmitting the invitation input from a second user device.

13. The method of claim 1, wherein transmitting the invitation input comprises transmitting the invitation input from a second user device comprising one of the following: a network interface unit, a residential gateway, a set-top box, a terminal unit, a scrambler/descrambler, a digital storage media unit, a control device, a television, an LCD screen, a cable modem, a computer, and a projection unit.

14. The method of claim 1, wherein transmitting the invitation input comprises transmitting the invitation input to a second user device being configured to store the invitation input in a database associated with the second user.

15. The method of claim 1, further comprising:
receiving an acceptance input from the second user, the acceptance input comprising an acceptance to the invitation input; and
transmitting the acceptance input to the first user in response to receiving the acceptance input.

16. A computer-readable medium which stores a set of instructions which when executed performs a method for providing a content mark, the method executed by the set of instructions comprising:
transmitting an invitation input to a second user;
receiving an acceptance of the invitation input from the second user; and
transmitting, in response to the received acceptance, the content to the second user, the content configured to start at a predetermined point determined by a first user.

17. The computer-readable medium of claim 16, further comprising receiving the invitation input from the first user.

18. The computer-readable medium of claim 17, wherein receiving the invitation input comprises receiving the invitation input comprising a recommendation to the second user to take an action regarding the content to be delivered over a content delivery system.

19. The computer-readable medium of claim 16, wherein transmitting the invitation input to the second user comprises transmitting the invitation input to the second user, the invitation input including a pointer corresponding to a predetermined point in content comprising Video-on-Demand content.

20. A system for providing a content mark, the system comprising:
a memory storage; and
a processing unit coupled to the memory storage, wherein the processing unit is operative to:
receive an invitation input over a content delivery system from a first user, the invitation input comprising a recommendation to a second user to take an action regarding content, the invitation input including a pointer corresponding to a predetermined point in the content and a duration of a portion of the content measured from the predetermined point;
transmit, over the content delivery system, the invitation input to the second user, the invitation input configured cause the content to start at the predetermined point; and
receive, over the content delivery system, an acceptance of the invitation input from the second user.
